(19) United States
(12) Patent Application Publication
(10) Pub. No.: US 2014/0307433 A1
(43) Pub. Date: Oct. 16, 2014

(54) REFLECTIVE DIFFUSION LENS AND LIGHTING INSTALLATION

(71) Applicant: Samsung Electronics Co., Ltd., Suwon-si (KR)

(72) Inventors: Cheoul Young KIM, Suwon-si (KR); Keun Bum Lee, Cheongwon-gun (KR); Seung Jae Lee, Seoul (KR); Sun Gil Kim, Suwon Si (KR); Chang Ju Kim, Yongin-si (KR); Geun Ho Lee, Yongin-si (KR); Dong Seob Jang, Seoul (KR)

(73) Assignee: Samsung Electronics Co., Ltd., Suwon-si (KR)

(21) Appl. No.: 14/248,788

(22) Filed: Apr. 9, 2014

(30) Foreign Application Priority Data
Apr. 10, 2013 (KR) 10-2013-0039404

(51) Int. Cl. F21V 13/04; F21V 7/04

(52) U.S. Cl. CPC F21V 13/04; F21V 7/04
USPC 362/235; 362/327

(57) ABSTRACT

A reflective diffusion lens may include a bottom surface concave toward a reflective surface, a longitudinal cross section of the bottom surface being formed in a parabolic shape or normal distribution shape such that light incident upon the bottom surface is incident upon the reflective surface, and the reflective surface concave toward the bottom surface. The reflective surface may include a concave surface having a longitudinal cross section formed in a parabolic shape or normal distribution shape to totally reflect the light transmitted from the bottom surface and incident upon the reflective surface. A lighting installation may include at least one light source to emit light, a reflective diffusion lens to collect light emitted from the light source, and a reflective plate positioned at a lower portion of the light source and adapted to adjust a direction or amount of light reaching the reflective plate.

### CROSS-REFERENCE TO RELATED APPLICATIONS

This application claims the priority benefit of Korean Patent Application No. 10-2013-0039404, filed on Apr. 10, 2013 in the Korean Intellectual Property Office, the disclosure of which is incorporated herein by reference.

### BACKGROUND

1. Field

Embodiments relate to a reflective diffusion lens for a direct type lighting installation.

2. Description of the Related Art

Backlight units (BLUs), which are used in liquid crystal displays (LCDs), include light-guide-plate type BLUs and direct type BLUs.

A light guide plate is a component to adjust luminance of a BLU and perform uniform lighting. The light guide plate is a plastic lens functioning to uniformly deliver light emitted from a cold-cathode fluorescent lamp (CCFL) to the entire surface of an LCD.

In the case of the light-guide-plate type lighting installation, it may be possible to manufacture a surface light source having an area equal to or greater than 1 m², a thickness less than 10 mm, and luminance uniformity equal to or greater than 80%.

However, as the size of the light guide plate increases, the yield rate may decrease along with increase in manufacturing costs and degradation of optical efficiency.

The direct type lighting installation has an optical efficiency increased by up to 1.5 times from that of the light-guide-plate type BLU. Accordingly, this type of lighting installation may reduce LED use and lower the manufacturing costs of the light guide plate.

### SUMMARY

In an aspect of one or more embodiments, there is provided a reflective diffusion lens including a reflective surface to reflect all incident light and a bottom surface.

In an aspect of one or more embodiments, there is provided an optical device including a reflective diffusion lens that may improve light diffusion effect over a conventional reflective diffusion lens and has an easy to manufacture structure.

In an aspect of one or more embodiments, there is provided a reflective diffusion lens includes a bottom surface concave toward a reflective surface, a longitudinal cross section of the bottom surface being formed in a parabolic shape or normal distribution shape such that light incident onto the bottom surface is incident onto the reflective surface, and the reflective surface concave toward the bottom surface, the reflective surface including a concave surface having a longitudinal cross section formed in a parabolic shape or normal distribution shape to totally reflect the light transmitted from the bottom surface and incident onto the reflective surface.

The concave surface of the reflective surface may have a curvature to totally reflect or refract light emitted from a light source at an angle equal to or less than 20 degrees with respect to a central axis of the reflective diffusion lens.

The concave surface of the reflective surface may have a curvature to totally reflect light emitted from a light source at an angle between 20 degrees and 60 degrees with respect to a central axis of the reflective diffusion lens.

A concave surface of the bottom surface may have a curvature to collect light emitted from a light source such that the collected light is emitted onto the reflective surface.

The parabolic shape or normal distribution shape of the longitudinal cross section of the bottom surface or reflective surface may be configured with a single curve inclined with respect to a central axis of the reflective diffusion lens.

The parabolic shape or normal distribution shape of the longitudinal cross section of the bottom surface or reflective surface may be configured with a plurality of curves inclined with respect to a central axis of the reflective diffusion lens, a plurality of straight lines inclined with respect to the central axis, or a combination thereof.

A depth of the concave surface of the reflective surface may be greater than a depth of a concave surface of the bottom surface.

Each of the bottom surface and the reflective surface may have a structure symmetric with respect to a central axis of the reflective diffusion lens.

The structure symmetric with respect to the central axis may include a structure rotationally symmetric with respect to the central axis.

In an aspect of one or more embodiments, there is provided a lighting installation includes at least one light source to emit light, a reflective diffusion lens positioned at an upper portion of the light source and adapted to diffuse the light emitted from the light source, and a reflective plate positioned at a lower portion of the light source and adapted to adjust a direction of a light ray reaching the reflective plate or an amount of light reaching the reflective plate, wherein the reflective diffusion lens includes a bottom surface concave toward a reflective surface, a longitudinal cross section of the bottom surface being formed in a parabolic shape or normal distribution shape such that light incident onto the bottom surface is incident onto the reflective surface, and the reflective surface concave toward the bottom surface, the reflective surface including a concave surface having a longitudinal cross section formed in a parabolic shape or normal distribution shape to totally reflect the light transmitted from the bottom surface and incident onto the reflective surface.

The concave surface of the reflective surface of the reflective diffusion lens may have a curvature to totally reflect or refract light emitted from the light source at an angle equal to or less than 20 degrees with respect to a central axis of the reflective diffusion lens.

The concave surface of the reflective surface of the reflective diffusion lens may have a curvature to totally reflect light emitted from the light source at an angle between 20 degrees and 60 degrees with respect to a central axis of the reflective diffusion lens.

A concave surface of the bottom surface of the reflective diffusion lens may have a curvature to collect light emitted from the light source such that the collected light is emitted onto the reflective surface.

The parabolic shape or normal distribution shape of the longitudinal cross section of the bottom surface or reflective surface of the reflective diffusion lens may be configured with a single curve inclined with respect to a central axis of the reflective diffusion lens.

The parabolic shape or normal distribution shape of the longitudinal cross section of the bottom surface or reflective surface of the reflective diffusion lens may be configured with a plurality of curves inclined with respect to a central axis of the reflective diffusion lens, a plurality of straight lines inclined with respect to the central axis, or a combination thereof.

The lighting installation according to claim 10, wherein a depth of the concave surface of the reflective surface of the reflective diffusion lens is greater than a depth of a concave surface of the bottom surface.

Each of the bottom surface and the reflective surface has a structure symmetric with respect to a central axis of the reflective diffusion lens.

The structure symmetric with respect to the central axis may include a structure rotationally symmetric with respect to the central axis.

The lighting installation may further include a diffusion plate positioned at an upper portion of the reflective diffusion lens and adapted to adjust a direction of a light ray or an amount of light.

In an aspect of one or more embodiments, there is provided a reflective diffusion lens includes a bottom surface concave toward a reflective surface, a longitudinal cross section of the bottom surface being formed in a parabolic shape such that light incident onto the bottom surface is incident onto the reflective surface, and the reflective surface concave toward the bottom surface, the reflective surface including a concave surface having a longitudinal cross section formed in a parabolic shape to totally reflect the light transmitted from the bottom surface and incident onto the reflective surface.

In an aspect of one or more embodiments, there is provided a reflective diffusion lens includes a bottom surface concave toward a reflective surface, a longitudinal cross section of the bottom surface being formed in a normal distribution shape such that light incident onto the bottom surface is incident onto the reflective surface, and the reflective surface concave toward the bottom surface, the reflective surface including a concave surface having a longitudinal cross section formed in a normal distribution shape to totally reflect the light transmitted from the bottom surface and incident onto the reflective surface.

### BRIEF DESCRIPTION OF THE DRAWINGS

These and/or other aspects will become apparent and more readily appreciated from the following description of embodiments, taken in conjunction with the accompanying drawings of which:

FIG. 1 is a perspective view illustrating a reflective diffusion lens;

FIG. 2 is a longitudinal cross-sectional view illustrating the reflective diffusion lens;

FIG. 3 is a longitudinal cross-sectional view illustrating a bottom surface and a reflective surface of the reflective diffusion lens;

FIG. 4 is a view illustrating the depths of the bottom surface and reflective surface of the reflective diffusion lens;

FIG. 5 is a view illustrating the paths that the light emitted from a light source follows after being totally reflected, refracted and reflected in the reflective diffusion lens;

FIG. 6 is a simplified view of the reflective diffusion lens illustrating a relation between the height and diameter of the reflective diffusion lens when light is totally reflected at the reflective surface;

FIG. 7 is a view illustrating a reflective diffusion lens with a bottom surface including a protrusion;

FIG. 8 is a view illustrating the structure of a lighting installation including the reflective diffusion lens;

FIG. 9 is a view illustrating a path along which light is diffused in the lighting installation; and

FIG. 10 is a view illustrating a path that light follows when the curvature of the reflective diffusion lens increases in the lighting installation.

### DETAILED DESCRIPTION

Reference will now be made in detail to embodiments, examples of which are illustrated in the accompanying drawings, wherein like reference numerals refer to like elements throughout.

An embodiment of a reflective diffusion lens 100 and a lighting installation 500 including the reflective diffusion lens 100 will be described in detail with reference to the accompanying drawings.

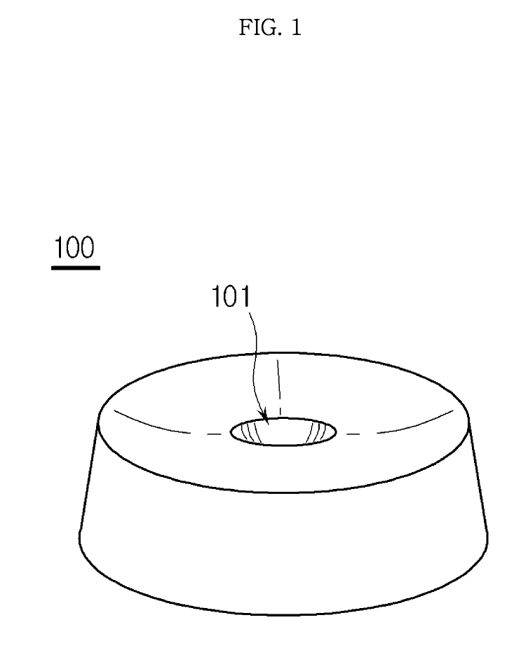

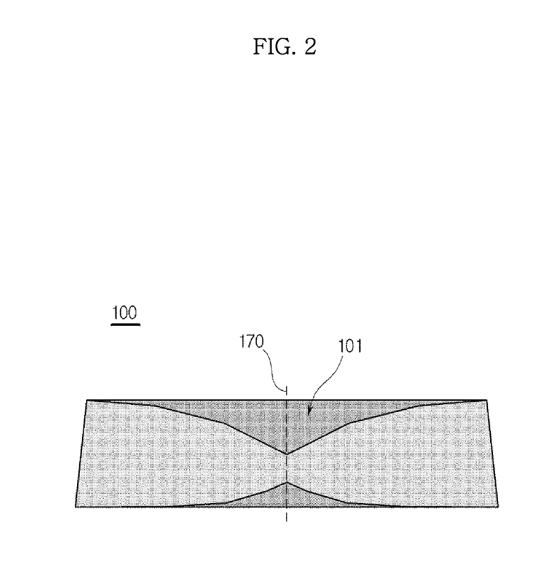

FIG. 1 is a perspective view illustrating the reflective diffusion lens 100, and FIG. 2 is a longitudinal cross-sectional view illustrating the reflective diffusion lens 100.

As shown in FIGS. 1 and 2, the reflective diffusion lens 100 has a shape of a circular truncated cone, and a groove 101 is formed at the center of a reflective surface 110 and a bottom surface 130. In addition, the longitudinal cross section of the reflective diffusion lens 100 has a trapezoidal shape. In FIG. 2, the left portion and the right portion of the lens are symmetrically arranged around the central axis of the lens.

In addition, the symmetric structure of the reflective diffusion lens 100 about the central axis includes a rotationally symmetric structure about the central axis.

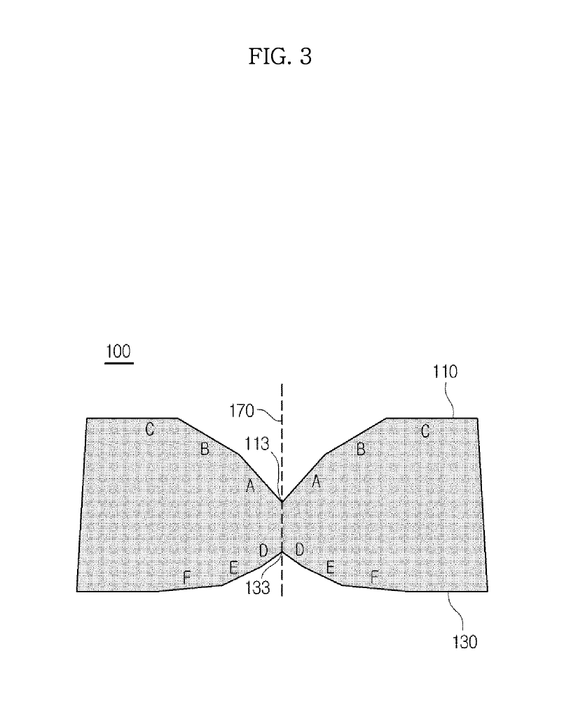

FIG. 3 is a cross-sectional view of the reflective diffusion lens 100 taken along the central axis 170.

As shown in FIG. 3, the reflective diffusion lens 100 includes a bottom surface 130 concave toward the reflective surface 110 and a reflective surface 110 concave toward the bottom surface 130. In addition, FIG. 3 shows an exaggerated view of the actual longitudinal cross section. The actual shape may differ from the illustrated view.

The longitudinal cross section of the reflective surface 110 has a shape of a parabola or a normal distribution shape.

The parabolic shape or normal distribution shape of the longitudinal cross section includes a straight line or a curve.

As shown in FIG. 3, the longitudinal cross section may be divided into a plurality of sections A, B and C. For ease of description, the longitudinal section will be divided into sections A, B and C. However, the cross section may be divided into more sections.

The parabolic shape or normal distribution shape of the longitudinal cross section of the reflective surface 110 includes a single curve on which sections A, B and C are inclined with respect to the central axis. In addition, the shape may include a plurality of curves on which sections A, B and C are inclined with respect to the central axis. In addition, the shape may include a plurality of straight lines on which sections A, B and C are inclined with respect to the central axis. In addition, the shape may include a mixture of straight lines and curves on which sections A, B and C are inclined with respect to the central axis.

In addition, the center 113 of the reflective surface may be pointed like the tip of a cone or may be blunt like an end of a sphere.

In addition, the parabolic shape or normal distribution shape of the longitudinal cross section of the reflective surface 110 may include a plurality of inflection points.

The longitudinal cross section of the bottom surface 130 has a parabolic shape or normal distribution shape.

The parabolic shape or normal distribution shape of the longitudinal cross section includes a straight line or a curve.

As shown in FIG. 3, the longitudinal cross section may be divided into a plurality of sections D, E and F. For ease of description, the longitudinal section will be assumed to be divided into sections D, E and F. However, the cross section may be divided into more sections.

The parabolic shape or normal distribution shape of the longitudinal cross section of the bottom surface 130 includes a single curve on which sections D, E and F are inclined with respect to the central axis. In addition, the shape may include a plurality of curves on which sections D, E and F are inclined with respect to the central axis. In addition, the shape may include a plurality of straight lines on which sections D, E and F are inclined with respect to the central axis. In addition, the shape may include a mixture of straight lines and curves on which sections D, E and F are inclined with respect to the central axis.

In addition, the center 133 of the bottom surface may be pointed like the tip of a cone or blunt like a sphere.

In addition, the parabolic shape or normal distribution shape of the longitudinal cross section of the bottom surface 130 may include a plurality of inflection points.

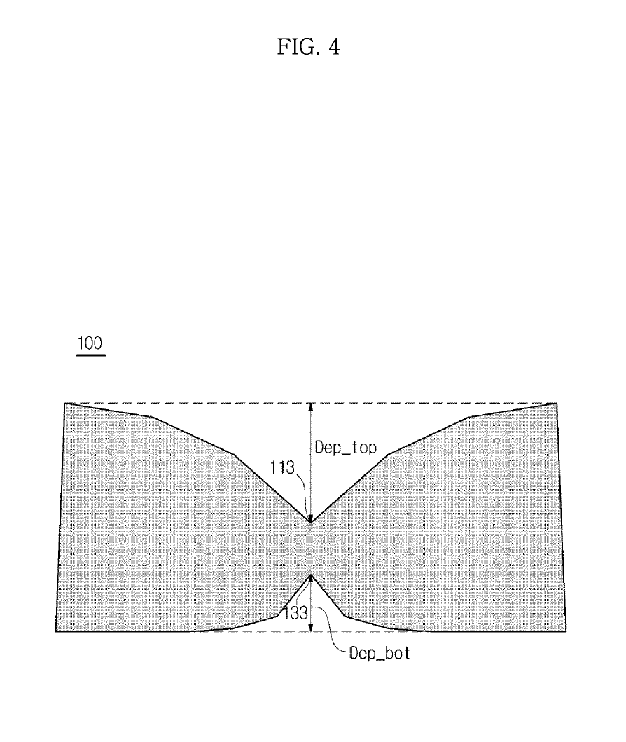

FIG. 4 is a view illustrating the depths of the bottom surface 130 and the reflective surface 110 of the reflective diffusion lens 100.

The depth of the reflective surface 110 of the reflective diffusion lens 100 is a distance from a plane including the corner of the reflective surface 110 of the reflective diffusion lens 100 to the center 113 of the reflective surface 110 of the reflective diffusion lens 100. The depth of the reflective surface 110 is defined as Dep_top.

In addition, the depth of the bottom surface 130 of the reflective diffusion lens 100 is a distance from a plane including the corner of the bottom surface 130 of the reflective diffusion lens 100 to the center 133 of the bottom surface 130 of the reflective diffusion lens 100. The depth of the bottom surface 130 is defined as Dep_bot.

As shown in FIG. 4, the depth of one surface of the reflective diffusion lens 100 is greater than the depth of the other surface. In one example, the depth of the reflective surface 110 is greater than that of the bottom surface 130.

To ensure effective total reflection at the reflective surface 110, the reflective diffusion lens 100 is manufactured such that the depth of the reflective surface 110 is greater than that of the bottom surface 130.

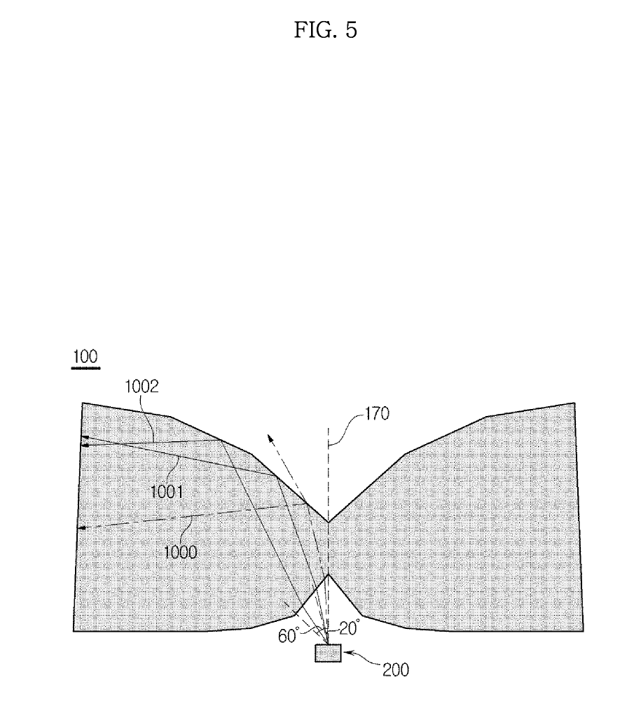

FIG. 5 is a view illustrating the paths that the light emitted from a light source 200 follows after being totally reflected, or refracted and reflected in the reflective diffusion lens 100.

Total reflection is a phenomenon that involves reflection of all light traveling through a medium of a higher index of refraction towards another medium of a lower index of refraction at the boundary when the light reaches the boundary at an angle of incidence greater than a critical angle. When light travels through a medium of a higher index of refraction towards another medium of a lower index of refraction, part of the light is transmitted through the boundary, while the remainder of the light is reflected at the boundary. However, when the angle of incidence increases beyond a particular angle, the light is entirely reflected at the boundary without being transmitted through the boundary.

Refraction is the change in direction of a wave when the wave enters a medium where its speed is changed.

That is, refraction is the change in travel direction of incident light when the light traveling through a medium of a lower index of refraction enters a medium of a higher index of refraction. The index of refraction of air is defined as n_s, and the index of refraction of the reflective diffusion lens 100 is defined as n_L. The reflective diffusion lens 100 is generally formed of glass, and accordingly the index of the reflective diffusion lens 100 is higher than that of air.

A more detailed description of refraction will be given in conjunction with a path of light.

As shown in FIG. 5, when light emitted from the light source 200 is incident upon the bottom surface 130 of the reflective diffusion lens 100, it is refracted. The refracted light is then incident upon the reflective surface 110, and refracted or totally reflected at the reflective surface 110. The light refracted at the reflective surface 110 is refracted at a side surface and then diffused. The totally reflected light is incident upon the bottom surface 130 of the reflective diffusion lens 100 and is then reflected or refracted and diffused through the side surface.

The light emitted from the light source 200 at an angle equal to or less than 20 degrees with respect to the central axis of the reflective diffusion lens 100 and incident upon the bottom surface 130 may be totally reflected, or refracted and reflected at the bottom surface 130.

The light ray 1000 is emitted onto the bottom surface 130 at an angle equal to or less than 20 degrees with respect to the central axis. The incident light is refracted. The refracted light is incident upon the reflective surface 110. The reflective surface 110 may be inclined at an angle with respect to the incident light such that a part of the light incident upon the reflective surface 110 is refracted and enters the air, and the remaining part of the light is reflected to travel through the reflective diffusion lens 100.

The light ray 1001 is emitted to the bottom surface 130 at an angle equal to or less than 20 degrees with respect to the central axis. The incident light is refracted. The refracted light is incident upon the reflective surface 110. The reflective surface 110 may be inclined at an angle with respect to the incident light such that the incident light is totally reflected at the reflective surface 110.

Light emitted from the light source 200 at an angle between 20 degrees and 60 degrees with respect to the central axis of the reflective diffusion lens 100 and incident upon the bottom surface 130 is totally reflected.

The light ray 1002 is emitted onto the bottom surface 130 at an angle between 20 degrees and 60 degrees with respect to the central axis. The incident light is refracted. The refracted light is incident upon the reflective surface 110. The reflective surface 110 may be inclined at an angle with respect to the incident light such that the incident light is totally reflected at the reflective surface 110.

That is, the bottom surface 130 has a curvature and an angle that minimize the radius of the reflective diffusion lens 100 within which the light rays emitted from the light source 200 at an angle between 20 degrees and 60 degrees with respect to the central axis 170 of the reflective diffusion lens 100 are totally reflected at the reflective surface 110.

The light rays 1000, 1001 and 1002 are all refracted at the bottom surface 130. The bottom surface 130 may be formed to be concave such that refraction occurs at the bottom surface 130 and thus light emitted from the light source 200 is concentrated. Thereby, the radius of the reflective diffusion lens 100 may be minimized.

In addition, light incident upon the reflective surface 110 is totally reflected or refracted depending upon the angle of incidence of the light, and the reflective surface 110 is fabricated using this principle of total reflection.

The reflective surface 110 includes a curved surface concave toward the bottom surface 130 in the form of a parabola or normal distribution curve. Thereby, it is easy to adjust the angle at which the light totally reflected at the reflective surface 110 of the reflective diffusion lens 100 is laterally diffused through the reflective diffusion lens 100.

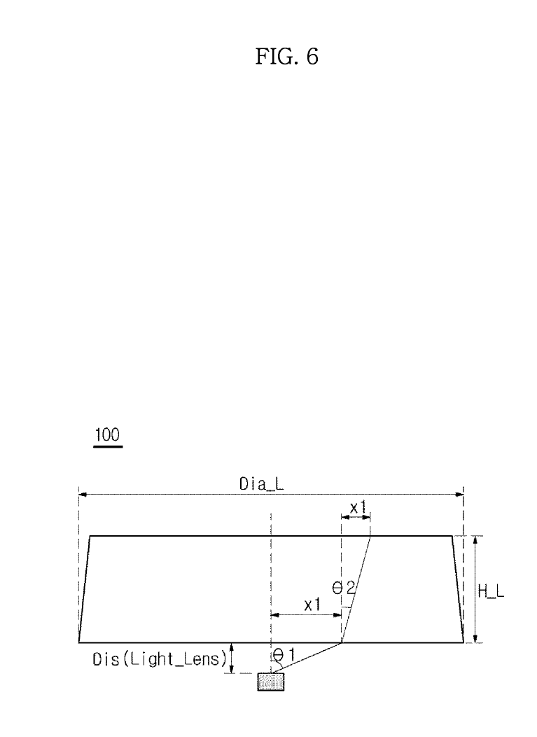

FIG. 6 is a simplified view of the reflective diffusion lens 100 illustrating a relation between the height and diameter of the reflective diffusion lens 100 when light is totally reflected at the reflective surface 110. Symbols shown in FIG. 6 will be first described, and then the conditions under which the reflective diffusion lens 100 totally reflects light will be described using equations.

As shown in FIG. 6, the height of the reflective diffusion lens 100 is a distance from a plane including the corner of the reflective surface 110 of the reflective diffusion lens 100 to a plane including the corner of the bottom surface 130 of the reflective diffusion lens 100, and is defined as H_L.

The distance from the light source 200 to the center 133 of the bottom surface 130 of the reflective diffusion lens 100 is a vertical distance from the light source 200 to a plane including the corner of the bottom surface 130 of the reflective diffusion lens 100, and is defined as Dis(Light_Lens).

The diameter 170 of the reflective diffusion lens 100 is determined based on the larger one of the reflective surface 110 and the bottom surface 130 that has a greater diameter. In the case of the reflective diffusion lens 100 shown in FIG. 4, the diameter of the bottom surface 130 is greater than that of the reflective surface 110, and thus the diameter 170 of the reflective diffusion lens 100 is determined based on the bottom surface 130 and is defined as Dia_L.

The angle of incidence of the light emitted from the light source 200 onto the bottom surface 130 of the reflective diffusion lens 100 with respect to the central axis 170 of the reflective diffusion lens 100 is defined as θ1, and the angle of refraction of the light refracted to travel through the reflective diffusion lens 100 with respect to a normal line is defined as θ2.

The distance from the center 133 of the bottom surface of the reflective diffusion lens 100 to the point on the bottom surface 130 of the reflective diffusion lens 100 onto which light is incident is defined as x1. The perpendicular distance from the point on the bottom surface 130 of the reflective diffusion lens 100 onto which light is incident to the point on the reflective surface 110 of the reflective diffusion lens 100 onto which the light is incident is defined as x2.

Using the symbols defined above, the following equation is obtained.

$$\frac{Dia\_L}{2} > x 1 + x 2 = Dis ( Light\_Lens ) \times tan {θ}_{1} + \text{?} \times tan {θ}_{2}$$

$$\text{?} \text{indicates text missing or illegible when filed}$$

According to Snell's law,

$$\frac{sin {θ}_{2}}{n\_s} = \frac{sin {θ}_{1}}{n\_L}$$

$${θ}_{2} = a sin ( \frac{sin {θ}_{1} \times n\_s}{n\_L} ) .$$

Therefore, the following equation is obtained.

$$DiaL \geq 2 \times [ Dis ( Light\_Lens ) \times tan {θ}_{1} + \text{?} \times tan ( a sin ( \frac{sin {θ}_{1} xn\_s}{n\_L} ) ) ] = 2 \times [ Dis ( Light\_Lens ) \times tan 60 ° + \text{?} \times tan ( a sin ( \frac{sin \text{?}}{n\_L} ) ) ]$$

$$\text{?} \text{indicates text missing or illegible when filed}$$

That is, when the reflective diffusion lens 100 is fabricated such that the height and diameter of the reflective diffusion lens 100 satisfy the above equation, light is totally reflected at the reflective surface 110.

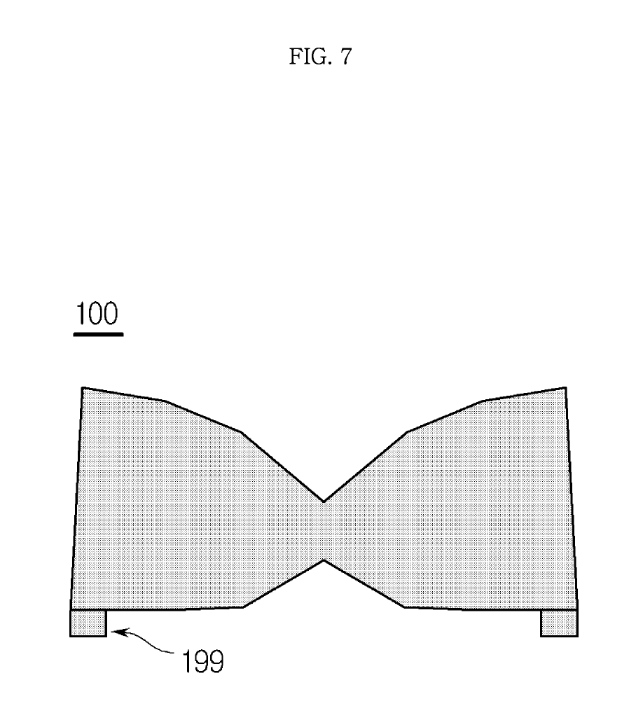

FIG. 7 is a view illustrating a reflective diffusion lens 100 with a bottom surface 130 including a protrusion 199.

As shown in FIG. 7, the reflective diffusion lens 100 may include a protrusion 199 provided to the bottom surface 130.

The protrusion 199 is positioned at a flat section of the bottom surface 130 of the reflective diffusion lens 100 which provides the shortest light path. The protrusion 199 may be fixed to a printed circuit board (PCB) or a reflective plate 300 in the form of a fixing mechanism.

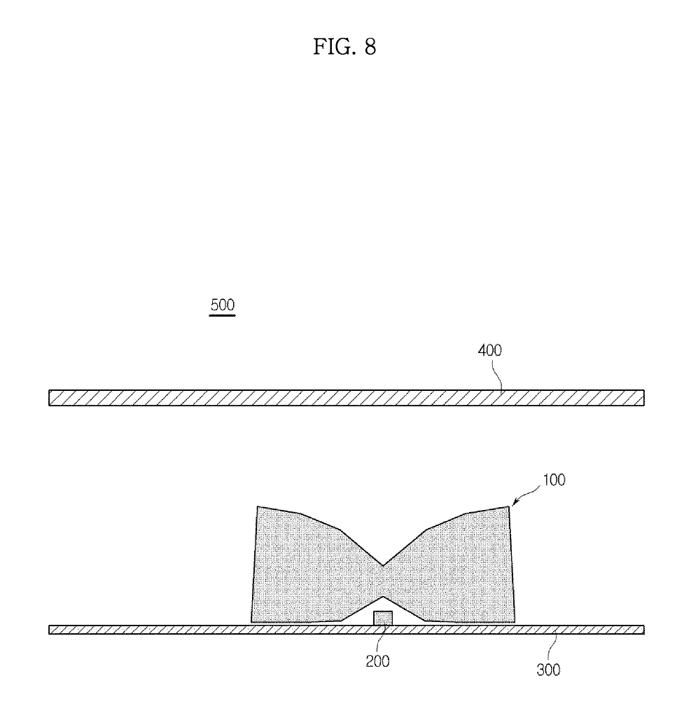

FIG. 8 is a view illustrating the structure of a lighting installation 500 including the reflective diffusion lens 100.

As shown in FIG. 8, the lighting installation 500 includes a light source 200, a reflective diffusion lens 100, and a reflective plate 300.

In addition, the lighting installation 500 may include a diffusion plate 400.

The light source 200 is positioned at an upper portion of the reflective plate 300 or a printed circuit board (PCB) and near the central axis 170 of the lower portion of the reflective diffusion lens 100. At least one light source 200 may be installed.

The reflective diffusion lens 100 is positioned at an upper portion of the reflective plate 300 or the printed circuit board (PCB). At least one reflective diffusion lens 100 may be included according to the width of the reflective plate 300 and desired brightness.

The reflective plate 300 is positioned at a lower portion of the reflective diffusion lens 100 and the light source 200. In addition, a structure to fix the reflective diffusion lens 100 and the light source 200 may be included.

The diffusion plate 400 is positioned at the upper portion of the reflective diffusion lens 100 to protect the reflective diffusion lens 100, the light source 200, and the reflective plate 300 from external stimulus.

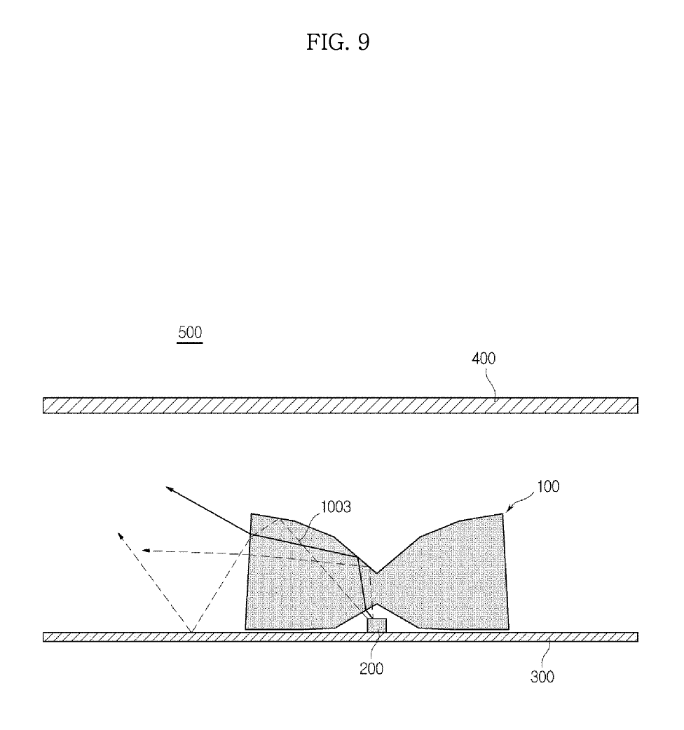

FIG. 9 is a view illustrating a path along which light is diffused in the lighting installation 500. Operation of the lighting installation 500 will be described with reference to FIG. 9.

The light source 200 is a device to radiate light. The light source 200 includes an LED lamp.

The light source 200 is installed at the upper portion of the reflective plate 300 or a printed circuit board (PCB). When necessary, a plurality of the light sources 200 may be provided. The direction of the light incident upon the reflective surface 110 is determined according to the angle of incidence.

The reflective diffusion lens 100 is used to diffuse light to convert point light or line light into surface light.

Operation of the reflective diffusion lens 100 has been described with reference to FIGS. 1 to 7, and thus a repetitive description will be avoided.

The reflective plate 300 is a device to reflect the light diffused at the side surface. The reflective plate 300 may include a white reflective film.

The light diffused from the reflective diffusion lens 100 may be incident upon the reflective plate 300. When light is reflected at the reflective plate 300 and diffused, distribution of the emitted light may be adjusted according to the reflectance of the reflective plate 300.

The reflectance of a common reflective plate 300 is 80% to 90%. The reflectance of the reflective plate 300 may be lowered according to a desired amount of emitted light. That is, when the reflectance of the reflective plate 300 is high, the amount of light emitted outward through the diffusion plate 400 increases. When the reflectance of the reflective plate 300 is low, the amount of light emitted outward through the diffusion plate 400 decreases.

The light ray 1003 is emitted from the side surface of the lens, incident upon the reflective plate 300, and then reflected at the reflective plate 300 toward the diffusion plate 400. By adjusting the amount of light reflected from the reflective plate 300 such as the light ray 1003 through adjustment of reflectance of the reflective plate 300, the total amount of light emitted from the diffusion plate 400 may be adjusted.

The diffusion plate 400 is a transparent optical plate including a surface pattern or a light diffusing agent to allow light transmitted through the reflective diffusion lens to be more uniformly diffused. The light diffused from the reflective diffusion lens 100 or the reflective plate 300 may be more uniformly distributed or the amount thereof may be adjusted using the diffusion plate.

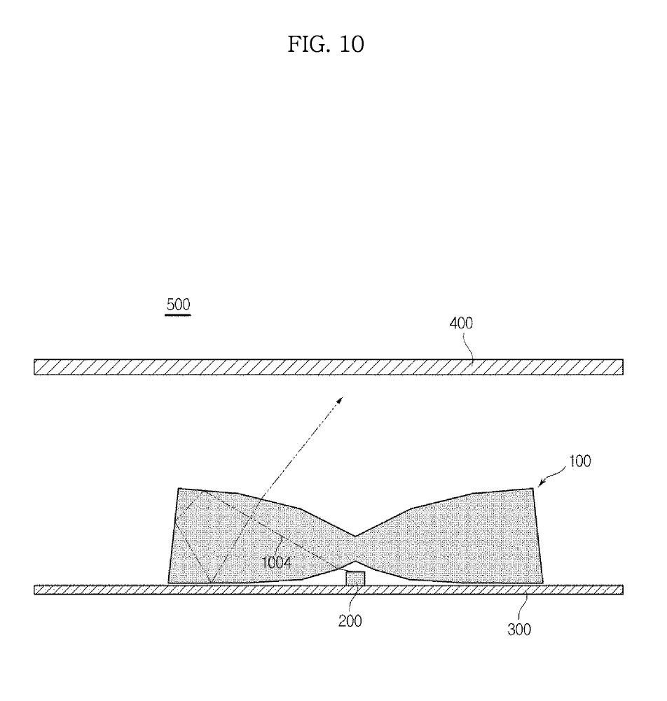

FIG. 10 is a view illustrating a path that light follows when the curvature of the reflective diffusion lens 100 increases.

As shown in FIG. 10, when the diameter of the reflective diffusion lens 100 is increased to extend the shape of the reflective diffusion lens 100 with the height thereof kept constant, the size of the bottom surface 130 and the curvature of the reflective surface 110 increase.

As the size of the bottom surface 130 and the curvature of the reflective surface 110 increase, light following the same path as that of the light ray 1004 is generated, and thus the amount of light emitted toward the central axis of the reflective diffusion lens increases.

The light ray 1004 is refracted at the bottom surface 130 when it enters the bottom surface 130. The refracted light is incident upon the reflective surface 110 and totally reflected. The totally reflected light may be incident again onto the side surface of the lens and totally reflected. The totally reflected light may be incident upon the bottom surface 130 and totally reflected again. The totally reflected light is incident upon the reflective surface 110. The incident light may be refracted and emitted toward the central axis. As a result, the amount of light emitted from the reflective diffusion lens 100 may increase near the central axis.

Based on the principle described above, the concave shape and curvature of the reflective diffusion lens 100 may be changed to adjust the distribution of light near the central axis 170.

As is apparent from the above description, light may be effectively diffused by adjusting the curvature of the reflective surface to reflect the total amount of light incident upon the reflective surface at an angle within a certain range of angle.

The diameter of a reflective diffusion lens may be reduced by adjusting the curvature of the bottom surface to concentrate the light incident upon the bottom surface.

Distribution of diffused light may be adjusted by adjusting the reflectance of a reflective plate.

The reflective diffusion lens is easier to manufacture than a conventional reflective diffusion lens, and therefore the time taken to manufacture a produce may be shortened and manufacturing costs may be reduced.

Although a few embodiments have been shown and described, it would be appreciated by those skilled in the art that changes may be made to embodiments without departing from the principles and spirit of the disclosure, the scope of which is defined in the claims and their equivalents.

What is claimed is:

1. A reflective diffusion lens comprising:
a bottom surface concave toward a reflective surface, a longitudinal cross section of the bottom surface being formed in a parabolic shape or normal distribution shape such that light incident upon the bottom surface is incident upon the reflective surface; and
the reflective surface concave toward the bottom surface, the reflective surface including a concave surface having a longitudinal cross section formed in a parabolic shape or normal distribution shape to totally reflect the light transmitted from the bottom surface and incident upon the reflective surface.

2. The reflective diffusion lens according to claim 1, wherein the concave surface of the reflective surface has a curvature to totally reflect or refract light emitted from a light source at an angle equal to or less than 20 degrees with respect to a central axis of the reflective diffusion lens.

3. The reflective diffusion lens according to claim 1, wherein the concave surface of the reflective surface has a curvature to totally reflect light emitted from a light source at an angle between 20 degrees and 60 degrees with respect to a central axis of the reflective diffusion lens.

4. The reflective diffusion lens according to claim 1, wherein a concave surface of the bottom surface has a curvature to collect light emitted from a light source such that the collected light is emitted to the reflective surface.

5. The reflective diffusion lens according to claim 1, wherein the parabolic shape or normal distribution shape of the longitudinal cross section of the bottom surface or reflective surface is configured with a single curve inclined with respect to a central axis of the reflective diffusion lens.

6. The reflective diffusion lens according to claim 1, wherein the parabolic shape or normal distribution shape of the longitudinal cross section of the bottom surface or reflective surface is configured with a plurality of curves inclined with respect to a central axis of the reflective diffusion lens, a plurality of straight lines inclined with respect to the central axis, or a combination thereof.

7. The reflective diffusion lens according to claim 1, wherein a depth of the concave surface of the reflective surface is greater than a depth of a concave surface of the bottom surface.

8. The reflective diffusion lens according to claim 1, wherein each of the bottom surface and the reflective surface has a structure symmetric with respect to a central axis of the reflective diffusion lens.

9. The reflective diffusion lens according to claim 8, wherein the structure symmetric with respect to the central axis includes a structure rotationally symmetric with respect to the central axis.

10. A lighting installation comprising:
at least one light source to emit light;
a reflective diffusion lens positioned at an upper portion of the light source and adapted to diffuse the light emitted from the light source; and
a reflective plate positioned at a lower portion of the light source and adapted to adjust a direction of a light ray reaching the reflective plate or an amount of light reaching the reflective plate,
wherein the reflective diffusion lens comprises:
a bottom surface concave toward a reflective surface, a longitudinal cross section of the bottom surface being formed in a parabolic shape or normal distribution shape such that light incident upon the bottom surface is incident upon the reflective surface; and
the reflective surface concave toward the bottom surface, the reflective surface including a concave surface having a longitudinal cross section formed in a parabolic shape or normal distribution shape to totally reflect the light transmitted from the bottom surface and incident upon the reflective surface.

11. The lighting installation according to claim 10, wherein the concave surface of the reflective surface has a curvature to totally reflect or refract light emitted from the light source at an angle equal to or less than 20 degrees with respect to a central axis of the reflective diffusion lens.

12. The lighting installation according to claim 10, wherein the concave surface of the reflective surface has a curvature to totally reflect light emitted from the light source at an angle between 20 degrees and 60 degrees with respect to a central axis of the reflective diffusion lens.

13. The lighting installation according to claim 10, wherein a concave surface of the bottom surface has a curvature to collect light emitted from the light source such that the collected light is emitted to the reflective surface.

14. The lighting installation according to claim 10, wherein the parabolic shape or normal distribution shape of the longitudinal cross section of the bottom surface or reflective surface is configured with a single curve inclined with respect to a central axis of the reflective diffusion lens.

15. The lighting installation according to claim 10, wherein the parabolic shape or normal distribution shape of the longitudinal cross section of the bottom surface or reflective surface is configured with a plurality of curves inclined with respect to a central axis of the reflective diffusion lens, a plurality of straight lines inclined with respect to the central axis, or a combination thereof.

16. The lighting installation according to claim 10, wherein a depth of the concave surface of the reflective surface is greater than a depth of a concave surface of the bottom surface.

17. The lighting installation according to claim 10, wherein each of the bottom surface and the reflective surface has a structure symmetric with respect to a central axis of the reflective diffusion lens.

18. The lighting installation according to claim 17, wherein the structure symmetric with respect to the central axis includes a structure rotationally symmetric with respect to the central axis.

19. The lighting installation according to claim 10, further comprising a diffusion plate positioned at an upper portion of the reflective diffusion lens and adapted to adjust a direction of a light ray or an amount of light.
